(19) United States
(12) Patent Application Publication
(10) Pub. No.: US 2012/0013593 A1
(43) Pub. Date: Jan. 19, 2012

(54) DISPLAY DEVICE

(75) Inventor: Keiichi Yamamoto, Osaka (JP)

(73) Assignee: SHARP KABUSHIKI KAISHA, Osaka (JP)

(21) Appl. No.: 13/256,597

(22) PCT Filed: Nov. 10, 2009
(86) PCT No.: PCT/JP2009/005992

§ 371 Date: Sep. 14, 2011

(30) Foreign Application Priority Data
Mar. 17, 2009 (JP) 2009-064223

(51) Int. Cl. G09G 5/00

(52) U.S. Cl. 345/211

(57) ABSTRACT

A display device includes: a first electrode and a second electrode which are arranged side by side with each other on a first substrate; a conductive layer which is arranged on a second substrate so as to face the first electrode and the second electrode; a voltage supply portion for applying a voltage to the first electrode through a first wiring line; a detection portion for detecting the voltage that is applied to the first electrode through the conductive layer, the second electrode, and a second wiring line as a result of the conductive layer making contact with the first electrode and the second electrode; and a second switching element which is interposed at least one of between the first electrode and the first wiring line and between the second electrode and the second wiring line.

### TECHNICAL FIELD

The present invention relates to a display device which detects positional information on a display screen.

### BACKGROUND ART

In recent years, thin display devices such as liquid crystal display devices, for example, are widely used for various devices, such as personal computers, mobile phones, PDAs, and game machines. Display devices detecting positional information on a display screen by having a touch panel arranged over a display panel are also known.

As touch panel methods, the resistive type and the optical type and the like, for example, are generally known.

In the resistive type, both a surface of a substrate bonded to a display panel and a surface on the substrate side of a film bonded over the surface of the substrate with a narrow gap have transparent conductive films bonded thereon. The respective transparent conductive films make contact with each other and electric current is made to flow at a position that is pressed by a finger or the tip of a pen and the like, and the position is to be detected thereby.

However, the configuration of placing a touch panel over a display panel has a problem of the reduction of display contrast due to reflected light generated from the surface of the display panel, the back surface of the touch panel, inside of the touch panel and from the surface of the touch panel.

Additionally, the loss of the display visual quality as a result of moireé produced by the respective reflected light interfering with each other is also a problem. Further, the structure of laminating a display panel and a touch panel causes another problem of increases in the thickness as well as in the weight of the entire display device.

In this connection, integration of a display panel with a resistive type touch panel has been disclosed (see Patent Documents 1 and 2 and the like, for example).

Patent Document 1 discloses that a first touch electrode is disposed over gate wiring lines and source wiring lines of a TFT substrate which constitutes a liquid crystal display panel, and a second touch electrode is disposed over black matrix of an opposite substrate to form the first and second touch electrodes in a grid pattern.

Patent Document 2 discloses that a plurality of pairs of contact electrodes are formed and arranged on a TFT substrate in a matrix and one contact electrode is connected to a detection line extending in the X direction, while the other contact electrode is connected to a detection line extending in the Y direction. In this manner, when a common electrode formed on an opposite substrate makes contact with the pair of contact electrodes at a touch position, the voltage at the common electrode is detected through the contact electrodes and the detection lines to detect the touch position.

### RELATED ART DOCUMENTS

### Patent Documents

Patent Document 1: Japanese Patent Application Laid-Open Publication No. 2001-075074

Patent Document 2: Japanese Patent Application Laid-Open Publication No. 2008-122913

### SUMMARY OF THE INVENTION

### Problems to be Solved by the Invention

The above-mentioned configuration of Patent Document 1, however, has a problem of not being able to detect positions of multiple points of two or more points on a display screen simultaneously.

Also, in the above-mentioned configuration of Patent Document 2, as shown in FIG. 19, which is an explanation drawing of touch positions, when two points, which are a point A (a, c) and a point B (b, d), are touched simultaneously in X-Y coordinates, a point C (a, d) and a point D (b, c) may be erroneously detected as being touched. Further, when the point A and the point B are being touched, even if the point C and the point D are touched, these points cannot be detected. Thus, even with the configuration of Patent Document 2, there is a problem that it is difficult to detect a plurality of positions of two or more points simultaneously with accuracy.

This invention was made in view of the above-mentioned points and it is an object of the present invention to detect a plurality of positions with accuracy.

### Means for Solving the Problems

To achieve the above-described object, a display device of the present invention includes a first substrate having thereon a plurality of pixel electrodes and a first switching element connected to the pixel electrode in each of a plurality of pixels, a second substrate placed opposite to the first substrate, a display medium layer disposed between the first substrate and the second substrate, a plurality of first electrodes formed on the first substrate; a plurality of second electrodes formed on the first substrate, the second electrodes being electrically insulated from each of the first electrodes and placed side by side with the first electrodes, respectively; a plurality of conductive layers arranged on the second substrate so as to respectively face pairs of the first electrode and the second electrode placed side by side with each other, the plurality of conductive layers being formed to be electrically insulated from each other; a plurality of first wiring lines and a plurality of second wiring lines formed on the first substrate; a voltage supply portion for applying a voltage to the first electrodes through the first wiring lines; a detection portion that detects the voltage applied to the first electrode by the voltage supply portion through the conductive layer, the second electrode, and the second wiring lines as a result of the conductive layer making contact with the first electrode and the second electrode when the first substrate or the second substrate is pressed; and a second switching element interposed at least one of between the first electrode and the first wiring line and between the second electrode and the second wiring line.

The second switching element may be a thin film transistor.

Further, in this case, a third wiring line may be connected to the second switching elements for applying a scan voltage to turn the second switching elements to the ON state.

Furthermore, the second switching element may be connected to the first wiring line and configured to be in the ON state when a voltage is supplied to the second switching element from the voltage supply portion through the first wiring line.

Alternatively, the second switching element may be a thin film diode.

The display device may further include a plurality of scan wiring lines and a plurality of signal wiring lines connected to the first switching elements on the first substrate and the second wiring lines may be the signal wiring lines.

The display device may further include a plurality of scan wiring lines and a plurality of signal wiring lines connected to the first switching elements on the first substrate, and the first wiring lines may be the scan wiring lines.

The display device may further include an opposite electrode on the second substrate, and the opposite electrode may be electrically insulated from the conductive layers.

Further, the first electrodes and the second electrodes may be made of the same material as that of the pixel electrodes.

Further, a pair of the first electrode and the second electrode may be disposed in each of the plurality of pixels, respectively.

Furthermore, the display medium layer may be a liquid crystal layer.

### Operations

Operations of the present invention are described hereinafter.

In the display device, the display of images is performed in each pixel by the first switching element driving the display medium layer such as a liquid crystal layer, for example, disposed between the opposite electrode and the pixel electrode.

When the first substrate or the second substrate is touched and pressed, the substrate is bent in the pressed direction and the conductive layer formed on the second substrate makes contact with both the first electrode and the second electrode formed on the first substrate. The first electrode and the second electrode are thereby electrically connected through the conductive layer.

At this time, (1) if a second switching element is allowing electric current to flow from the first wiring line to the second wiring line through the first electrode and the second electrode, and further, (2) if a voltage is applied to the first electrode from the voltage supply portion through the first wiring line, the voltage applied to the first electrode is detected by the detection portion through the conductive layer, the second electrode, and the second wiring line to detect the pressed position (touch position).

Further, because the second switching element is disposed for each pair of the first electrode and the second electrode placed side by side with each other, and the plurality of first wiring lines and second wiring lines are also disposed, by scanning the respective first wiring lines sequentially, a plurality of pressed positions (touch positions) can be detected simultaneously with accuracy for every pair of the first electrode and the second electrode.

The second switching element may be a thin film transistor or a thin film diode, for example. When the second switching element is a thin film transistor, a third wiring line for applying a scan voltage that turns the second switching element to the ON state may be connected.

In this case, at a position where the first substrate or the second substrate is touched and pressed, (1) if a scan voltage is applied to the second switching element through the third wiring line and the second switching element is thereby in the ON state, and (2) if a voltage of the voltage supply portion is being supplied to the first electrode through the first wiring line, the voltage of the first electrode is detected by the detection portion through the conductive layer, the second electrode, and the second wiring line to detect the pressed position.

Also, in a case where the second switching element is a thin film transistor, the second switching element may be connected to the first wiring line so as to turn to the ON state when a voltage is supplied from the voltage supply portion through the first wiring line. This makes it possible to omit the third wiring line.

In this case, at a position where the first substrate or the second substrate is touched and pressed, if a voltage of the voltage supply portion is supplied to the first wiring line, and the voltage is supplied to the second switching element through the first wiring line, (1) turning the second switching element to the ON state, and also, (2) if the voltage is supplied to the first electrode, the voltage of the first electrode (which is a scan voltage of the second switching element) is detected by the detection portion through the conductive layer, the second electrode, and the second wiring line, thereby detecting the pressed position.

In a case where the second switching element is a thin film diode, (1) a flow of electric current running from the first wiring line side to the second wiring line side is allowed by the diode. Therefore, at a position where the first substrate or the second substrate is touched and pressed, (2) if a voltage from the voltage supply portion is supplied to the first electrode, when the first electrode is electrically connected to the second electrode through the conductive layer, the voltage of the first electrode is detected by the detection portion through the conductive layer, the second electrode, and the second wiring line, thereby detecting the pressed position.

In a case where a plurality of scan wiring lines and a plurality of signal wiring lines connected to the first switching elements are formed on the first substrate, the second wiring lines may be constituted by the signal wiring lines. That is, while a signal voltage is supplied from the signal wiring line to the pixel electrode through the first switching element to display images, a voltage of the first electrode is detected by the detection portion through the conductive layer, the second electrode, and the signal wiring line.

Also, as described above, in a case where a plurality of scan wiring lines and a plurality of signal wiring lines connected to the first switching elements are formed on the first substrate, the first wiring lines may be constituted by the scan wiring lines. That is, while a scan voltage is supplied from the scan wiring lines to the first switching element, turning the first switching element to the ON state to display images, a voltage from the voltage supply portion is supplied to the first electrode through the scan wiring line.

If the first electrodes and the second electrodes are constituted of the same material as that of the pixel electrodes, these electrodes can be simultaneously formed in the same process, and the manufacturing cost can be thereby reduced.

If a pair of the first electrode and the second electrode is disposed in each of the pixels, respectively, the highly accurate detection of pressed positions (touch positions) can be made possible for every pixel.

If the display medium layer is a liquid crystal layer, the display device can perform the liquid crystal display as well as the detection of pressed positions (touch positions) of a plurality of points.

### Effects of the Invention

According to the present invention, because each pair of the first electrode and the second electrode placed side by side with each other is provided with the conductive layer facing to these electrodes, and the second switching element and a voltage of the voltage supply portion is supplied to the first electrode through the plurality of first wiring lines, while the voltage supplied to the first electrode is detected by the detection portion through the second wiring line, the conductive layer, and the second electrode, by scanning the respective first wiring lines sequentially, a plurality of pressed positions (touch positions) can be detected with accuracy for every pair of the first electrode and the second electrode.

### BRIEF DESCRIPTION OF THE DRAWINGS

FIG. 1 is a plan view schematically showing a circuit configuration of a TFT substrate that constitutes a liquid crystal display device of Embodiment 1.

FIG. 2 is a circuit diagram showing an enlarged view of a pixel of a liquid crystal display device of Embodiment 1.

FIG. 3 is a cross-sectional diagram showing a schematic structure of a liquid crystal display device of Embodiment 1.

FIG. 4 is a cross-sectional diagram showing an enlarged view of a part of an opposite substrate in Embodiment 1.

FIG. 5 is a waveform diagram showing a voltage supplied to each scan line.

FIG. 6 is an explanatory drawing showing touched positions and output of detection lines detected according to the touched positions.

FIG. 7 is a circuit diagram showing a detection system of a touch position in Embodiment 1.

FIG. 8 is a waveform diagram showing input and output voltages in a detection system during one scanning period in Embodiment 1.

FIG. 9 is a circuit diagram showing an enlarged view of a pixel of a liquid crystal display device according to Embodiment 2.

FIG. 10 is a circuit diagram showing a detection system of a touch position in Embodiment 2.

FIG. 11 is a waveform diagram showing input and output voltages in a detection system during one scanning period in Embodiment 2.

FIG. 12 is a circuit diagram showing an enlarged view of a pixel of a liquid crystal display device according to Embodiment 3.

FIG. 13 is a circuit diagram showing a detection system of a touch position in Embodiment 3.

FIG. 14 is a waveform diagram showing input and output voltages in a detection system during one scanning period in Embodiment 3.

FIG. 15 is a circuit diagram showing an enlarged view of a pixel of a liquid crystal display device according to Embodiment 4.

FIG. 16 is a circuit diagram showing a detection system of a touch position in Embodiment 4.

FIG. 17 is a waveform diagram showing input and output voltages in a detection system during one scanning period in Embodiment 4.

FIG. 18 is a circuit diagram showing an enlarged view of a pixel of a liquid crystal display device according to Embodiment 5.

FIG. 19 is an explanatory diagram showing touched positions in a conventional display device.

### DETAILED DESCRIPTION OF EMBODIMENTS

Hereinafter, embodiments of the present invention are described in detail with reference to the figures, but the present invention is not limited to such embodiments.

### Embodiment 1

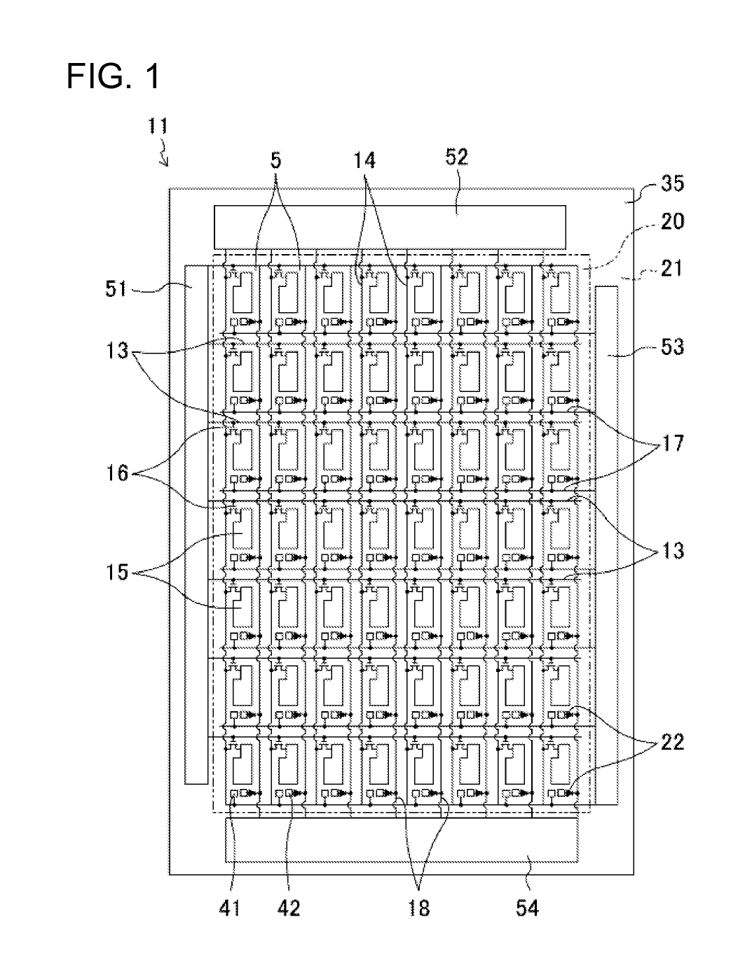

FIGS. 1 to 8 show Embodiment 1 of the present invention.

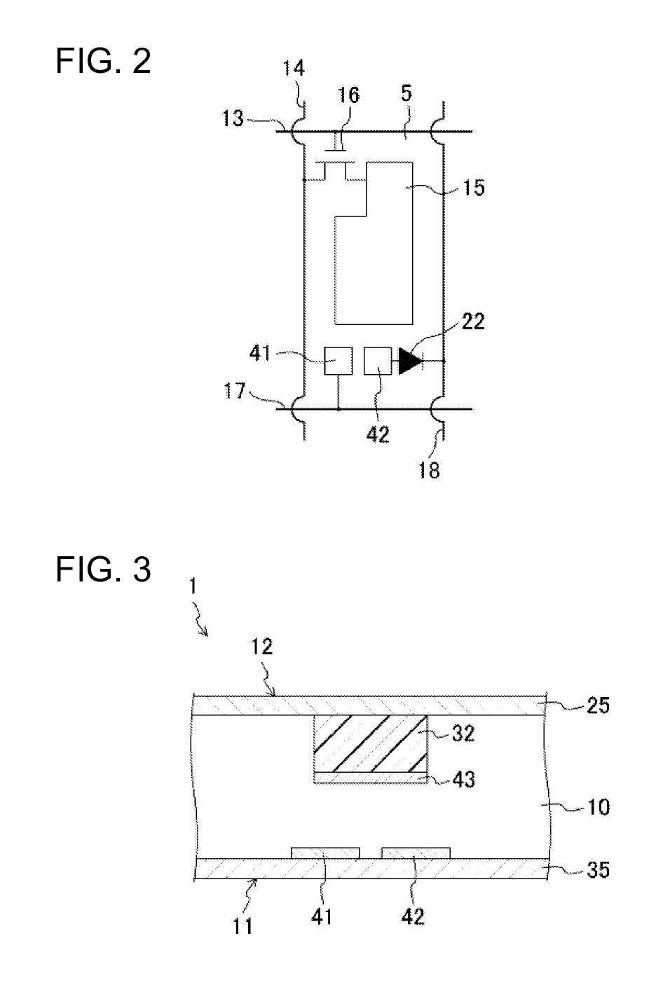

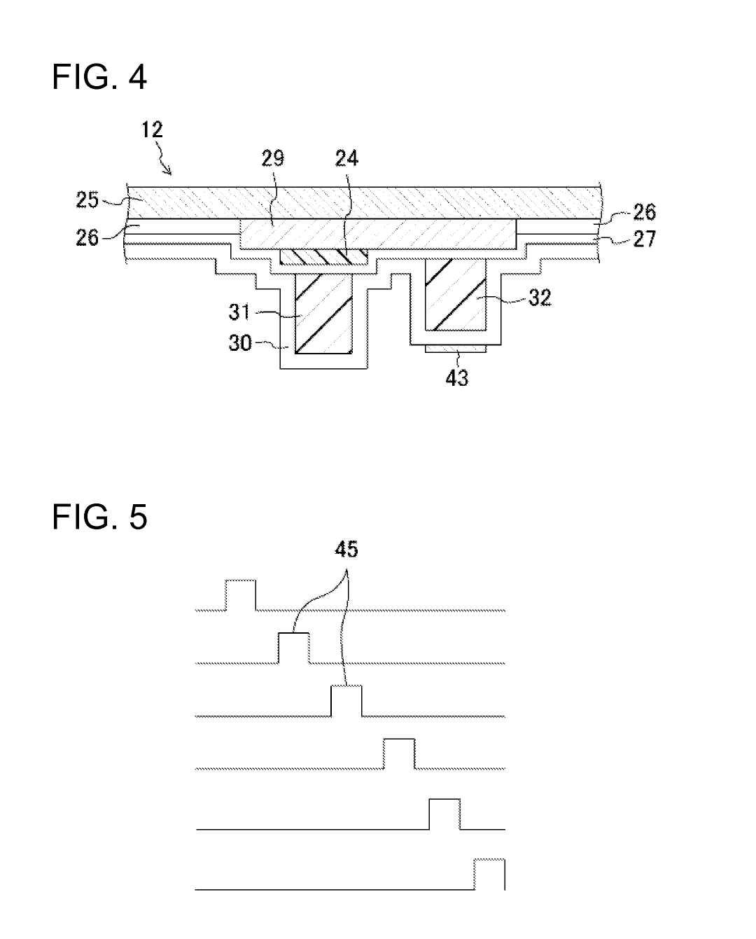

FIG. 1 is a plan view schematically showing a circuit structure of a TFT substrate 11 that constitutes a liquid crystal display device 1 of Embodiment 1. FIG. 2 is a circuit diagram showing an enlarged view of a pixel 5 of the liquid crystal display device 1 of Embodiment 1. FIG. 3 is a cross-sectional diagram showing a schematic structure of the liquid crystal display device 1 of Embodiment 1. FIG. 4 is a cross-sectional diagram showing an enlarged view of a part of an opposite substrate 12 in Embodiment 1. FIG. 5 is a waveform diagram showing a voltage supplied to each scan line 17.

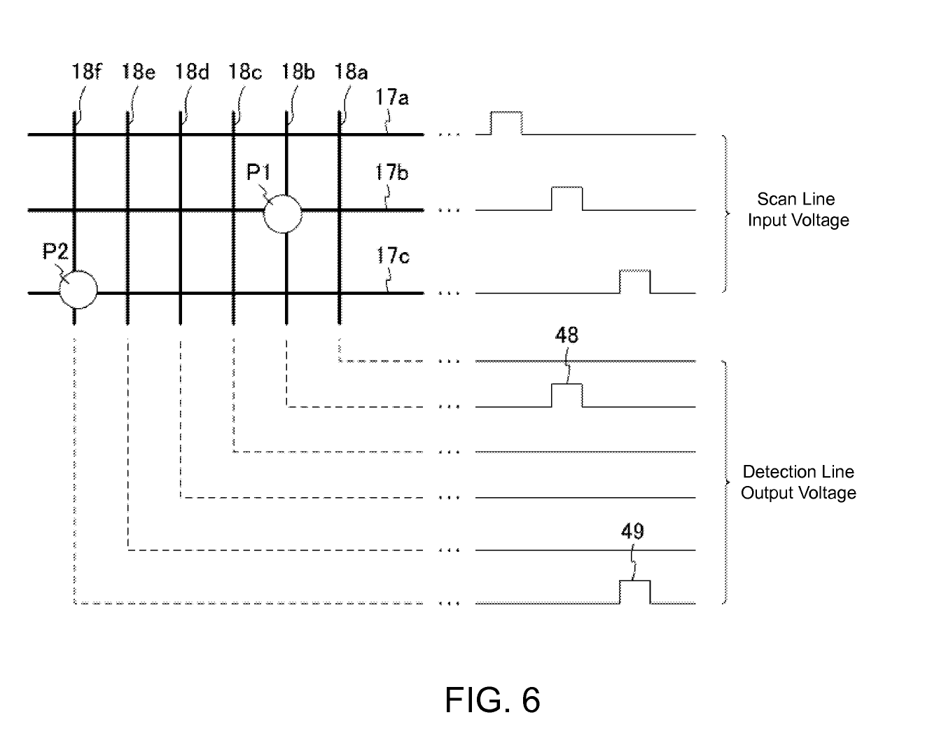

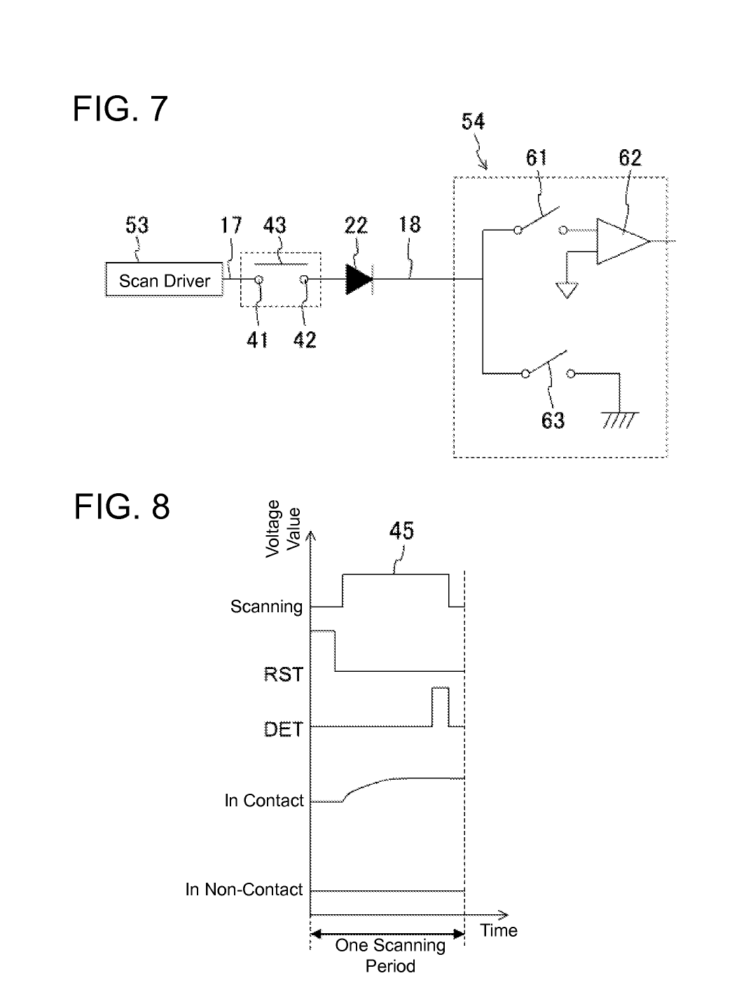

FIG. 6 is an explanatory drawing showing touched positions and output of detection lines 18 detected according to the touched positions. FIG. 7 is a circuit diagram showing a detection system of a touch position in Embodiment 1. FIG. 8 is a waveform diagram showing input and output voltages in the detection system during one scanning period in Embodiment 1.

### Configuration of Liquid Crystal Display Device

In Embodiment 1, a liquid crystal display device is explained as an example. The liquid crystal display device 1 of Embodiment 1 is configured as a transmissive liquid crystal display device capable of transmissive display, for example.

As shown in FIG. 3, the liquid crystal display device 1 includes: a TFT substrate 11, which is a first substrate; an opposite substrate 12, which is a second substrate placed opposite to the TFT substrate 11; and a liquid crystal layer 10, which is a display medium layer provided between these opposite substrate 12 and TFT substrate 11.

As shown in FIG. 1, the liquid crystal display device 1 has a display region 20 which is rectangular in shape, for example, and a frame region 21 which is a non-display region formed around the display region 20 in a frame-like shape. The display region 20 is constituted of a plurality of pixels 5 arranged in a matrix.

### Configuration of Opposite Substrate

As shown in FIG. 4, the opposite substrate 12 includes a glass substrate 25 having a thickness of 0.7 mm or less, for example, a color filter layer 26 formed on the liquid crystal layer 10 side of the glass substrate 25, and a black matrix 29, which is a light shielding film, and an opposite electrode (common electrode) 27. On a part of the surface of the black matrix 29, a spacer base portion 24 made of the same material and formed in the same thickness as those of a colored layer of the color filer layer 26 is formed.

The opposite electrode 27 is made of ITO (Indium Tin Oxide), for example, and formed almost across the entire display region uniformly. That is, the spacer base portion 24, the color filter layer 26, and the black matrix 29 are covered by the opposite electrode 27 formed by evaporating ITO.

On the surface of the opposite electrode 27, in the region where the spacer base portion 24 is disposed, a columnar spacer 31 is formed by photolithography to define the thickness of the liquid crystal layer 10 (a so-called cell gap). Additionally, on the surface of the opposite electrode 27, in the region where the black matrix 29 is formed, a touch sensor projection 32 is formed.

The touch sensor projection 32 is made of the same photosensitive material, and formed in the same length as those of the columnar spacer 31. The touch sensor projection 32 is formed simultaneously with the columnar spacer 31 by photolithography.

Because the spacer base portion 24 is interposed between the columnar spacer 31 and the black matrix 29, the tip of the columnar spacer 31 is placed closer to the TFT substrate 11 side than the touch sensor projection 32.

On the surface on the liquid crystal layer 10 side of the opposite electrode 27, an alignment film 30 is formed so as to cover the columnar spacer 31 and the touch sensor projection 32. The alignment film 30 is made of polyimide or the like, for example. In FIG. 3, the alignment film 30 is not shown. Additionally, a not-shown polarizing plate is bonded on a surface of the glass substrate 25 on a side opposite to the liquid crystal layer 10.

### Configuration of TFT Substrate

The TFT substrate 11 is configured as a so-called active matrix substrate as shown in FIG. 1. The TFT substrate 11 has a glass substrate 35 in the thickness of 0.7 mm or less, for example, as shown in FIG. 3, and has a plurality of gate lines 13, which are scan wiring lines, formed to extend parallel to each other as shown in FIG. 1.

Additionally, on the TFT substrate 11, a plurality of source lines 14, which are signal wiring lines, are formed so as to extend to cross the gate lines 13. Therefore, on the TFT substrate 11, the wiring lines constituted of the gate lines 13 and the source lines 14 is formed in a grid pattern.

As shown in FIG. 1, each pixel 5 is formed in a rectangular shaped region divided by the gate lines 13 and the source lines 14 in the display region 20. In each pixel 5, a plurality of pixel electrodes 15 placed opposite to the opposite electrode 27, and a TFT (Thin-Film Transistor) 16, which is a first switching element connected to the pixel electrode 15 and used for switching-driving the liquid crystal layer 10, are formed, respectively.

The TFT 16 is arranged in the left top corner area in FIGS. 1 and 2 in the pixel 5, for example, and has a gate electrode (not shown) connected to the gate line 13, a source electrode (not shown) connected to the source line 14, and a drain electrode (not shown) connected to the pixel electrode 15. In other words, the gate line 13 and the source line 14 are connected to the TFT 16.

Meanwhile, in the frame region 21 of the TFT substrate 11, a gate driver 51 connected to the gate lines 13, a source driver 52 connected to the source lines 14, a scan driver 53 connected to scan lines 17, which will be described later, and a detection driver 54 connected to detection lines 18, which will be described later, are arranged along the respective sides of the TFT substrate 11.

Therefore, with a scan voltage being applied to a gate electrode of the TFT 16 (not shown) from the gate driver 51 through the gate line 13, by supplying signal voltages from the source driver 52 and from the source lines 14, to the pixel electrode 15 through source electrodes (not shown) and drain electrodes (not shown) of the TFTs 16, the liquid crystal layer 10 is driven by the potential difference occurring between the pixel electrodes 15 and the opposite electrode 27, and thereby a desired image is displayed.

### First Electrode and Second Electrode

As shown in FIGS. 1 to 3, the TFT substrate 11 has a plurality of first electrodes 41, and a plurality of second electrodes 42 that are electrically insulated from each of the first electrodes 41, and that are placed side by side with the respective first electrodes 41, formed on the glass substrate 35 thereof. In Embodiment 1, a pair of the first electrode 41 and the second electrode 42 is placed in each pixel 5, respectively.

The first electrode 41 and the second electrode 42 are respectively made of ITO, which is the same material as that of the pixel electrode 15, and are formed in smaller sizes than that of the pixel electrode 15. While the pixel electrode 15 is covered by an alignment film (not shown), the first electrode 41 and the second electrode 42 are exposed, not being covered by the alignment film (not shown).

### Scan Line and Detection Line

Additionally, as shown in FIGS. 1 and 2, a plurality of scan lines 17, which are first wiring lines, and a plurality of detection lines 18, which are second wiring lines, are formed on the TFT substrate 11. Each scan line 17 is formed along the gate line 13. On the other hand, each detection line 18 is formed along the source line 14. That is, these scan lines 17 and detection lines 18 are formed in a grid pattern as a whole.

As shown in FIG. 2, as for a pair of the first electrode and the second electrode, the first electrode 41 is connected to the scan line 17, while the second electrode 42 is connected to the detection line 18 through a TFD (Thin-Film Diode) 22 as a second switching element. The TFD 22 allows electric current to flow from the second electrode 42 to the detection line 18.

In Embodiment 1, an example of arranging the TFD 22 between the second electrode 42 and the detection line 18 is described, but the present invention is not limited to this, and the TFD 22 that allows electric current to flow from the scan line 17 side to the detection line 18 side may be interposed at least either between the first electrode 41 and the scan line 17 or between the second electrode 42 placed side by side with the first electrode 41 and the detection line 18.

### Conductive Layer

Meanwhile, as shown in FIGS. 3 and 4, on the opposite substrate 12, a plurality of conductive layers 43 are placed so as to face the respective pairs of the first electrode 41 and the second electrode 42 placed side by side with each other. The plurality of conductive layers 43 are formed to be electrically insulated from each other. Additionally, each of the conductive layers 43 is electrically insulated from the opposite electrode 27 as well.

The conductive layer 43 is formed on the tip side of the touch sensor projection 32 (the TFT substrate 11 side), and is exposed, not being covered by the alignment film 30. The conductive layer 43 is formed by ITO vapor-deposited on the alignment film 30, for example. Alternatively, the conductive layer 43 can be formed by a resin having conductivity, for example.

### Scan Driver and Detection Driver

Also, as shown in FIG. 1, the scan driver 53 connected to the scan lines 17 is configured as a voltage supply portion that applies voltages to the first electrodes 41 through the scan lines 17.

Meanwhile, the detection driver 54 connected to the detection lines 18 is configured as a detection portion that detects a voltage applied to the first electrode 41 by the scan driver 53 through the conductive layer 43, the second electrode 42, and the detection line 18 as a result of the conductive layer 43 making contact with both of the first electrode 41 and the second electrode 42 when the TFT substrate 11 or the opposite substrate 12 is pressed.

As shown in FIG. 7, the detection driver 54 includes a comparator circuit portion 62 connected to the detection line 18 through a DET switch 61, and an RST switch 63 connected to the detection line 18 in parallel with the DET switch 61. Additionally, an input side of the comparator circuit portion 62 is connected to a voltage reference.

The DET switch 61 connects the detection line 18 and the comparator circuit portion 62 in the ON state, while the RST switch 63 electrically grounds the detection line 18 in the ON state.

### Touch Position Detection Method

Hereinafter, a touch position detection method according to the above-mentioned liquid crystal display device 1 is explained.

When the TFT substrate 11 or the opposite substrate 12 is touched and pressed, the pressed substrate is bent in the pressed direction and the conductive layer 43 formed on the opposite substrate 12 makes contact with both the first electrode 41 and the second electrode 42 formed on the TFT substrate 11. The first electrode 41 and the second electrode 42 are thereby electrically connected through the conductive layer 43.

Meanwhile, as shown in FIG. 5, in the entire display region 20, scan lines 17 are scanned row by row sequentially, and a HIGH voltage 45 is supplied from the scan driver 53.

As shown in FIGS. 7 and 8, before the HIGH voltage 45 is supplied to the scan line 17 in one row, the detection driver 54 turns the DET switch 61 connected to the detection line 18 to the OFF state, and turns the RST switch 63 to the ON state to remove electric charge in this detection line 18 in advance for resetting. After that, the RST switch 63 is turned to the OFF state and the scanning of the scan line 17 is started.

Here, the horizontal axis in FIG. 8 shows time, while the vertical axis shows the magnitude of voltage values. Also, one scanning period refers to a period for a series of processes performed for each scan line 17 of one row.

When the HIGH voltage 45 is supplied to the scan line 17 of the one row in which the scanning has been started, the HIGH voltage 45 is supplied to all of the first electrodes 41 connected to the scan line 17. At this time, if the TFT substrate 11 or the opposite substrate 12 is touched and pressed, and if any of the first electrodes 41 is electrically connected to the second electrode 42 through the conductive layer 43, the HIGH voltage 45 of the first electrode 41 at the touch position will be supplied to the detection line 18 through the second electrode 42.

Here, as shown in FIG. 8, the voltage value supplied to the detection line 18 gradually increases. The voltage supplied sufficiently to the detection line 18 is supplied to the comparator circuit portion 62 by turning the DET switch 61 to the ON state, and as a result of the AD conversion, the voltage is detected by the detection driver 54.

On the other hand, if no touch is performed on the scan line 17 of the one row in which the scanning has been started, the HIGH voltage 45 of the first electrode 41 will not be supplied to the detection line 18, and as shown in FIG. 8, it will not be detected by the detection driver 54. In other words, non-contact is detected by the detection driver 54.

This series of processes is performed for every row of the scan line 17 row by row. The touch position detection is thereby performed for the entire display region 20.

Referring to FIG. 6, the position detection in a case where two points are touched simultaneously will be explained.

In FIG. 6, the scan lines 17a to 17c are disposed in the row direction and the detection lines 18a to 18f are disposed in the column direction. At a point P1 and a point P2, the TFT substrate 11 or the opposite substrate 12 is touched and pressed.

The point P1 is positioned adjacent to a pair of electrodes 41 and 42 constituted by the first electrode 41 connected to the scan line 17b and the second electrode 42 connected to the detection line 18b. Meanwhile, the point P2 is positioned adjacent to a pair of electrodes 41 and 42 constituted by the first electrode 41 connected to the scan line 17c and the second electrode 42 connected to the detection line 18f.

In FIG. 6, the scan lines 17a to 17c are scanned starting from the top row. First, when the scan line 17a is scanned, no voltage value is detected in the detection lines 18a to 18f. Next, when the scan line 17a is scanned, because the first electrode 41 and the second electrode 42 are electrically connected through the conductive layer 43 at the point P1, the voltage 48 that has been supplied to the first electrode 41 is detected through the detection line 18b.

Next, when the scan line 17c is scanned, because the first electrode 41 and the second electrode 42 are electrically connected through the conductive layer 43 at the point P2, the voltage 49 that has been supplied to the first electrode 41 is detected through the detection line 18f. As a result, the point P1 and the point P2 are respectively detected with certainty.

### Effects of Embodiment 1

Thus, in Embodiment 1, each pair of the first electrode 41 and the second electrode 42 arranged side by side with each other is provided with the conductive layer 43 and the TFD 22 placed opposite to these electrodes 41 and 42. Also, the voltage of the scan driver 53 is supplied to the first electrode 41 through the plurality of scan lines 17 and the voltage supplied to the first electrode 41 at a touch position is detected by the detection driver 54 through the conductive layer 43, the second electrode 42, and the detection line 18. Therefore, by scanning the respective scan lines 17 sequentially, each touch position can be detected by a respective pair of the first electrode 41 and the second electrode 42 with high degree of accuracy, without detecting a wrong touch position even when two or more points are touched simultaneously.

Further, because the first electrodes 41 and the second electrodes 42 are made of ITO, which is same as the pixel electrode 15, these electrodes 15, 41 and 42 can be formed simultaneously in the same process and the manufacturing cost can be thereby reduced.

Furthermore, because the scan lines 17 and the detection lines 18 are provided separately and independently from the gate lines 13 and the source lines 14, a touch position can be detected anytime independently from the control of display by the gate lines 13 and the source lines 14. Therefore, the detection accuracy can be further enhanced.

Also, because a pair of the first electrode 41 and the second electrode 42 is provided in each pixel 5, a touch position can be detected with high degree of accuracy for every pixel 5.

### Embodiment 2

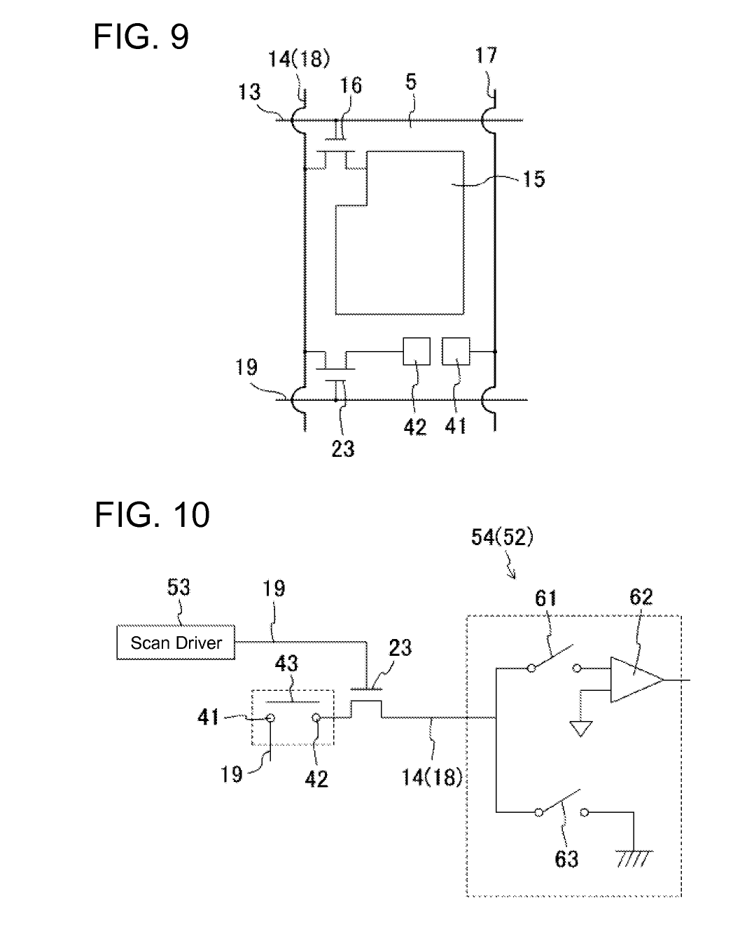

FIGS. 9 to 11 show Embodiment 2 of the present invention. Also, in each of the embodiments hereinafter, the same numerical references are given to the same members as those in FIGS. 1 to 8, and detailed explanations thereof are not repeated.

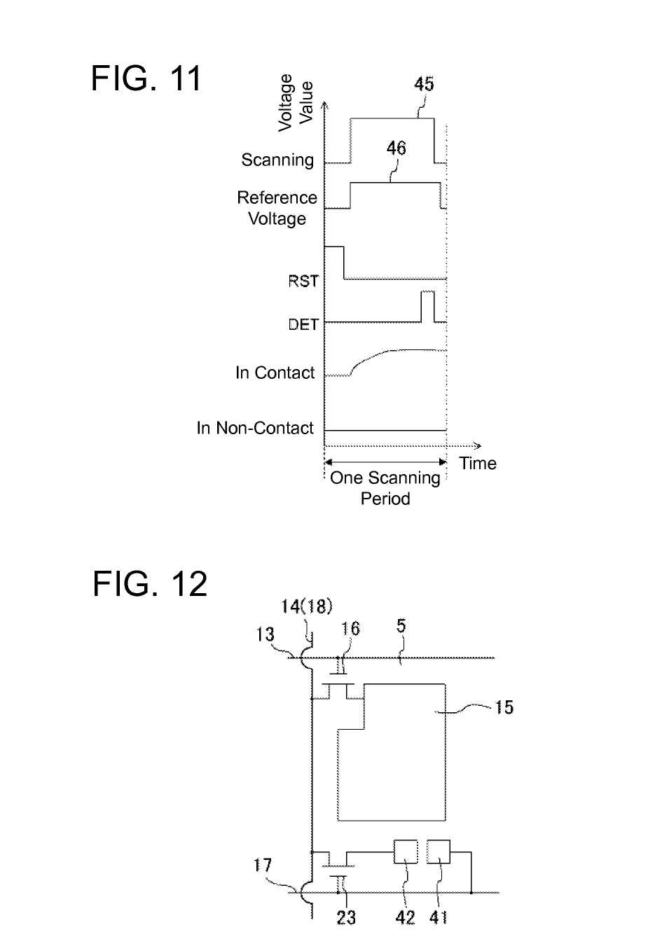

FIG. 9 is a circuit diagram showing an enlarged view of a pixel 5 of a liquid crystal display device 1 of Embodiment 2. FIG. 10 is a circuit diagram showing a detection system of a touch position in Embodiment 2. FIG. 11 is a waveform diagram showing input and output voltages in the detection system during one scanning period in Embodiment 2.

### Configuration of TFT Substrate

While the TFD 22 was provided as a second switching element in Embodiment 1 above, Embodiment 2 differs from Embodiment 1 in that a TFT (Thin-Film Transistor) 23 is provided as a second switching element as shown in FIGS. 9 and 10. Further, in Embodiment 2, the source lines 14 are configured to function as detection lines. That is, the source lines 14 double as the detection lines 18.

Further, while a plurality of scan lines 17 were provided as the first wiring lines that supply a voltage to the first electrodes 41 in Embodiment 1 above, Embodiment 2 also differs from Embodiment 1 in that it includes a plurality of reference voltage lines 17. Each of the reference voltage lines 17 is formed so as to extend parallel to the source line 14 (detection line 18), respectively, and is connected to the first electrode 41.

Also, in Embodiment 2, a plurality of scan lines 19 are provided as third wiring lines for applying a scan voltage to turn the TFTs 23 to the ON state. Each of the scan lines 19 is formed so as to extend parallel to the gate line 13, is connected to the gate electrode (not shown) of the TFT 23, and is connected to the scan driver 53, respectively. A scan voltage is thereby supplied to the scan lines 19 of respective rows sequentially from the scan driver 53.

While the source electrode of the TFT 23 (not shown) is connected the source line 14 (detection line 18), the drain electrode of the TFT 23 (not shown) is connected to the second electrode 42. In this manner, the TFT 23 allows electric current to flow from the reference voltage line 17 side to the source line 14 (detection line 18) side when a scan voltage is being supplied from the scan line 19.

In Embodiment 2, an example of arranging the TFT 23 between the second electrode 42 and the detection line 18 is described, but the present invention is not limited to this, and the TFT 23 may be interposed at least either between the first electrode 41 and the reference voltage line 17 or between the second electrode 42 and the detection line 18.

Alternatively, in a case where the second switching element, such as the TFD 22 and the TFT 23, is not disposed in all pixels 5, but is disposed in every two pixels, for example, the source line corresponding to the pixel adjacent to the pixel 5 may double as the reference voltage line 17.

In Embodiment 2, the scan driver 53 is placed so as to face the gate driver 51 in the frame region 21 of the TFT substrate 11. The source driver 52 of Embodiment 2 has the function of the detection driver 54 of Embodiment 1 above. Also, in the frame region 21, a reference voltage driver (not shown) is placed so as to face the source driver 52 (detection driver 54).

### Touch Position Detection Method

Hereinafter, a touch position detection method according to the above-mentioned liquid crystal display device 1 is explained.

When the TFT substrate 11 or the opposite substrate 12 is touched and pressed, the pressed substrate is bent in the pressed direction and the conductive layer 43 formed on the opposite substrate 12 makes contact with both the first electrode 41 and the second electrode 42 formed on the TFT substrate 11. The first electrode 41 and the second electrode 42 are thereby electrically connected through the conductive layer 43.

Meanwhile, in the entire display region 20, the scan lines 19 are scanned row by row sequentially, and the HIGH voltage 45 is supplied to the scan lines 19 from the scan driver 53.

As shown in FIGS. 10 and 11, before the HIGH voltage 45 is supplied to the scan line 19 in one row, the source driver 52 (detection driver 54) turns the DET switch 61 connected to the source line 14 to the OFF state, and turns the RST switch 63 to the ON state to remove electric charge in this source line 14 in advance for resetting.

After that, the RST switch 63 is turned to the OFF state, and with a reference voltage 46 being supplied to the reference voltage line 17 from the reference voltage driver (not shown), the scanning of the scan line 19 is started.

When the HIGH voltage 45 is supplied to the scan line 19 of the one row in which the scanning has been started, all of the TFTs 23 connected to the scan line 19 go into the ON state simultaneously. Meanwhile, the reference voltage 46 is supplied to each of the first electrodes 41 from the reference voltage line 17.

At this time, if the TFT substrate 11 or the opposite substrate 12 is touched and pressed, and if any of the first electrodes 41 is electrically connected to the second electrode 42 through the conductive layer 43, the reference voltage 46 of the first electrode 41 at the touch position will be supplied to the source line 14 (detection line 18) through the TFT 23.

Also, as shown in FIG. 11, the voltage value supplied to the source line 14 gradually increases. The voltage supplied sufficiently to the source line 14 is supplied to the comparator circuit portion 62 by turning the DET switch 61 to the ON state. As a result, the voltage is detected by the source driver 52 (detection driver 54).

Meanwhile, if no touch is performed on the scan line 19 of the one row in which the scanning has been started, the reference voltage 46 of the first electrode 41 will not be supplied to the source line 14, and as shown in FIG. 11, it will not be detected by the source driver 52 (detection driver 54).

This series of processes is performed for the every row of the scan line 19 row by row. The touch position detection is thereby performed for the entire display region 20.

### Effects of Embodiment 2

Thus, according to Embodiment 2, each of the pairs of the first electrodes 41 and the second electrodes 42 is provided with the conductive layer 43 and the TFT 23 placed opposite thereto. Also, the reference voltage 46 of the reference voltage driver (not shown) is supplied to the first electrodes 41 through the plurality of reference voltage lines 17, and the reference voltage 46 supplied to the first electrode 41 at a touch position is detected by the source driver 52 (detection driver 54) through the conductive layer 43, the second electrode 42, and the source line 14. Therefore, by scanning the respective scan lines 19 sequentially, each touch position can be detected by a respective pair of the first electrode 41 and the second electrode 42 with high degree of accuracy, without detecting a wrong touch position even when two or more points are touched simultaneously.

Further, because the detection lines 18 double as the source lines 14, the number of lines can be reduced, and therefore, the aperture ratio of the pixel 5 can be improved.

Furthermore, if the reference voltage line 17 is commonly used as the source line corresponding to pixel adjacent to the pixel 5, the aperture ratio of the pixel 5 can be further improved.

### Embodiment 3

FIGS. 12 to 14 show Embodiment 3 of the present invention.

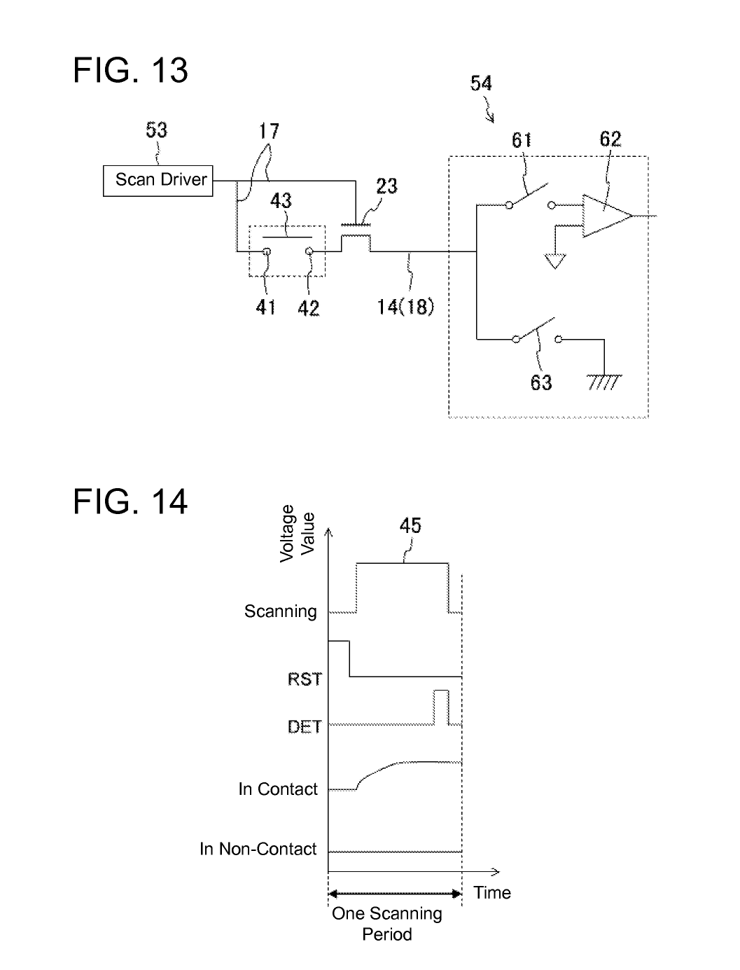

FIG. 12 is a circuit diagram showing an enlarged view of a pixel 5 of a liquid crystal display device 1 of Embodiment 3. FIG. 13 is a circuit diagram showing a detection system of a touch position in Embodiment 3. FIG. 14 is a waveform diagram showing input and output voltages in a detection system during one scanning period in Embodiment 3.

### Configuration of TFT Substrate

In Embodiment 2 above, the reference voltage lines 17 were provided as the first wiring lines and were connected to the first electrodes 41, while the scan lines 19 were provided as the third wiring lines and were connected to gate electrodes (not shown) of the TFTs 23. In contrast, in Embodiment 3, as shown in FIG. 12, the reference voltage line 17 is not provided, but the scan line 17 as the first wiring line is provided so as to extend parallel to the gate line 13, and both the first electrode 41 and the gate electrode of the TFT 23 (not shown) are connected thereto.

The scan lines 17 are connected to the scan driver 53 as the voltage supply portion in the frame region 21. Meanwhile, the source lines 14 double as the detection lines 18 and are connected to the source driver 52 (detection driver 54) in the frame region 21.

In this manner, the TFT 23 is configured such that when a voltage is supplied to the first electrode 41 from the scan driver 53 through the scan line 17, the TFT 23 becomes the ON state by the same voltage supplied thereto.

In Embodiment 3, an example of arranging the TFT 23 between the second electrode 42 and the detection line 18 is described, but the present invention is not limited to this, and the TFT 23 may be interposed at least either between the first electrode 41 and the scan line 17 or between the second electrode 42 and the detection line 18.

### Touch Position Detection Method

Hereinafter, a touch position detection method according to the above-mentioned liquid crystal display device 1 is explained.

In the entire display region 20, the scan lines 17 are scanned row by row sequentially, and the HIGH voltage 45 is supplied from the scan driver 53. As shown in FIGS. 13 and 14, before the HIGH voltage 45 is supplied to the scan line 17 in one row, the source driver 52 (detection driver 54) turns the DET switch 61 connected to the source line 14 to the OFF state, and turns the RST switch 63 to the ON state to remove electric charge in this source line 14 in advance for resetting. After that, the RST switch 63 is turned to the OFF state and the scanning of the scan line 17 is started.

When the HIGH voltage 45 is supplied to the scan line 17 of the one row in which the scanning has been started, all of the TFTs 23 connected to the scan line 17 go into the ON state simultaneously, and the HIGH voltage 45 is supplied to all of the first electrodes 41 connected to the scan line 17 simultaneously.

At this time, if the TFT substrate 11 or the opposite substrate 12 is touched and pressed, and if any of the first electrodes 41 is electrically connected to the second electrode 42 through the conductive layer 43, the HIGH voltage 45 of the first electrode 41 at the touch position is supplied to the source line 14 (detection line 18) through the TFT 23.

Also, as shown in FIG. 14, the voltage value supplied to the source line 14 gradually increases. The voltage supplied sufficiently to the source line 14 is supplied to the comparator circuit portion 62 by turning the DET switch 61 to the ON state. As a result, the voltage is detected by the source driver 52 (detection driver 54).

On the other hand, if no touch is performed on the scan line 19 of the one row in which the scanning has been started, the HIGH voltage 45 of the first electrode 41 will not be supplied to the source line 14, and as shown in FIG. 14, it will not be detected by the source driver 52 (detection driver 54).

This series of processes is performed for every row of the scan line 17 row by row. The touch position detection is thereby performed for the entire display region 20.

### Effects of Embodiment 3

Thus, according to Embodiment 3, each of the pairs of the first electrodes 41 and the second electrodes 42 is provided with the conductive layer 43 and the TFT 23 placed opposite thereto. Also, the scan voltage 45 is supplied to the TFT 23 through the scan line 17 of each row. At the same time, the scan voltage 45 is supplied to the first electrode 41 connected to the scan line 17, and the scan voltage 45 supplied to the first electrode 41 at a touch position is detected by the source driver 52 (detection driver 54) through the conductive layer 43, the second electrode 42, and the source line 14. Therefore, by scanning the respective scan lines 17 sequentially, each touch position can be detected by a respective pair of the first electrode 41 and the second electrode 42 with high degree of accuracy, without detecting a wrong touch position even when two or more points are touched simultaneously.

Further, because the detection lines 18 double as the source lines 14, and the reference voltage lines double as the scan lines 17, the number of lines can be greatly reduced, and therefore, the aperture ratio of the pixel 5 can be further improved.

### Embodiment 4

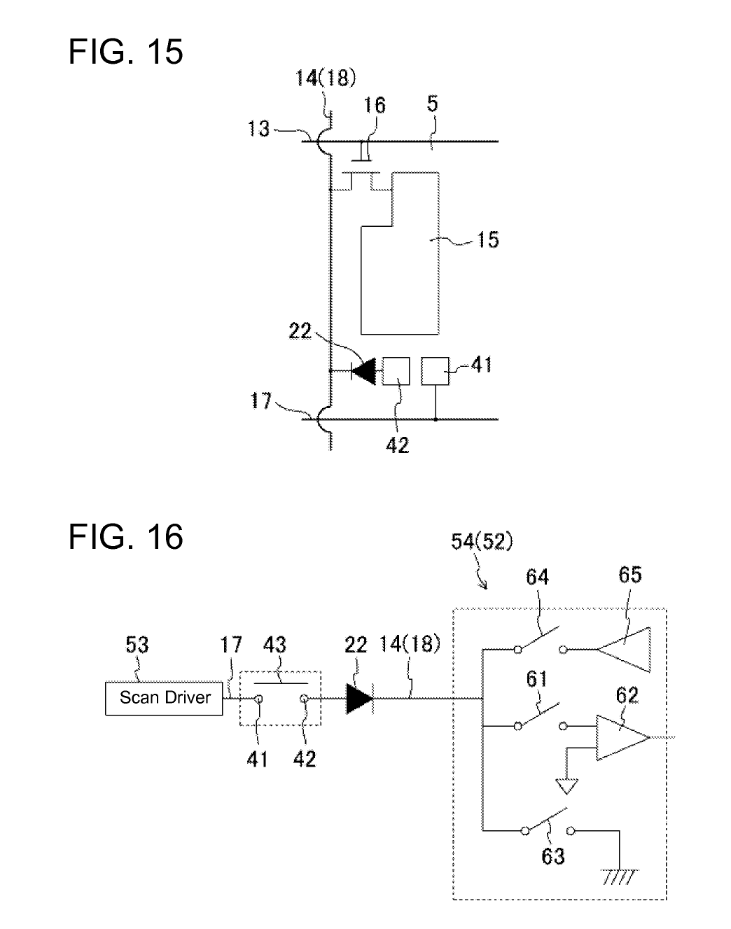

FIGS. 15 to 17 show Embodiment 4 of the present invention.

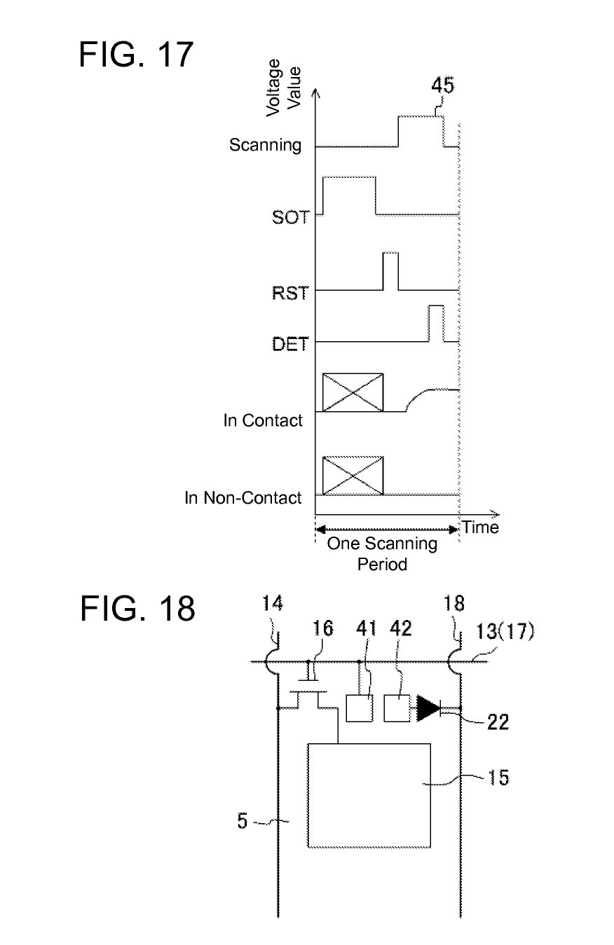

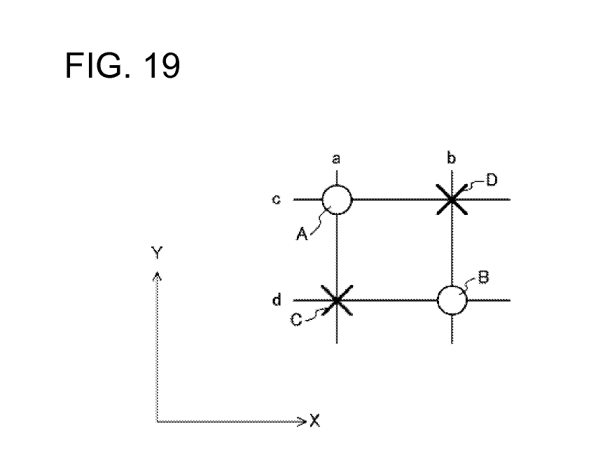

FIG. 15 is a circuit diagram showing an enlarged view of a pixel 5 of a liquid crystal display device 1 of Embodiment 4. FIG. 16 is a circuit diagram showing a detection system of a touch position in Embodiment 4. FIG. 17 is a waveform diagram showing input and output voltages in a detection system during one scanning period in Embodiment 4.

### Configuration of TFT Substrate

In Embodiment 4, the source line 14 of above Embodiment 1 doubles as the detection line 18.

That is, as shown in FIG. 15, while the first electrode 41 is connected to the scan line 17 as the first wiring line, the second electrode 42 is connected to the source line 14 (detection line 18) as the second wiring line through the TFD 22.

As shown in FIG. 16, the detection driver 54 includes a comparator circuit portion 62 connected to the source line 14 (detection line 18) through a DET switch 61, a RST switch 63 connected to the source line 14 in parallel with the DET switch 61, and an amplifier circuit portion 65 connected to the source line 14 through an SOT switch 64. Also, the input side of the comparator circuit portion 62 is connected to a reference voltage.

In Embodiment 4, an example of arranging the TFD 22 between the second electrode 42 and the detection line 18 is described, but the present invention is not limited to this, and the TFD 22 that allows electric current to flow from the scan line 17 side to the detection line 18 side may be interposed at least one of between the first electrode 41 and the scan line 17 and between the second electrode 42 and the detection line 18.

### Touch Position Detection Method

Hereinafter, a touch position detection method according to the above-mentioned liquid crystal display device 1 is explained.

First, as shown in FIGS. 16 and 17, during a period of performing display of images, the SOT switch 64 is in the ON state, and the RST switch 63 and the DET switch 61 are in the OFF state. The gate lines 13 are scanned row by row and a scan voltage is supplied sequentially from the gate driver 51. In each pixel 5 of the one row that has been scanned, a signal voltage is supplied from the source driver 52 to the pixel electrode 15 through the source line 14 and the TFT 16 that is in the ON state. In this manner, a desired image is displayed in respective pixels 5.

After that, in order to detect a touch position, the SOT switch 64 is turned to the OFF state, and the RST switch 63 is turned to the ON state to remove electric charge of the source line 14 for resetting. Then, after the RST switch 63 is turned to the OFF state, the scanning of the scan lines 17 is started.

When a HIGH voltage 45 is supplied from the scan driver 53 to the scan line 17 of one row in which the scanning has been started, the HIGH voltage 45 is supplied to all of the first electrodes 41 connected to the scan line 17 simultaneously.

At this time, if the TFT substrate 11 or the opposite substrate 12 is touched and pressed, and if any of the first electrodes 41 is electrically connected to the second electrode 42 through the conductive layer 43, the HIGH voltage 45 of the first electrode 41 at the touch position is supplied to the source line 14 through the second electrode 42.

Also, as shown in FIG. 17, the voltage value supplied to the source line 14 gradually increases. The voltage supplied sufficiently to the source line 14 is supplied to the comparator circuit portion 62 by turning the DET switch 61 to the ON state. As a result, the voltage is detected by the source driver 52 (detection driver 54).

Meanwhile, if no touch is performed on the scan line 17 of the one row in which the scanning has been started, the HIGH voltage 45 of the first electrode 41 will not be supplied to the source line 14, and as shown in FIG. 17, non-contact will be detected by the source driver 52 (detection driver 54).

This series of processes is performed for every row of the scan line 17 row by row. The image display and the touch position detection are thereby performed for the entire display region 20.

### Effects of Embodiment 4

Thus, according to Embodiment 4, each of the pairs of the first electrodes 41 and the second electrodes 42 is provided with the conductive layer 43 and the TFD 22. Also, the HIGH voltage 45 of the scan driver 53 is supplied to the first electrodes 41 through a plurality of the scan lines 17, and the HIGH voltage 45 supplied to the first electrode 41 at a touch position is detected by the source driver 52 (detection driver 54) through the conductive layer 43, the second electrode 42, and the source line 14. Therefore, by scanning the respective scan lines 17 sequentially, each touch position can be detected by a respective pair of the first electrode 41 and the second electrode 42 with high degree of accuracy, without detecting a wrong touch position even when two or more points are touched simultaneously.

Further, because the detection lines 18 double as the source lines 14, the number of lines can be reduced, and therefore, the aperture ratio of the pixel 5 can be further improved compared to Embodiment 1 above.

### Embodiment 5

FIG. 18 shows Embodiment 5 of the present invention.

FIG. 18 is a circuit diagram showing an enlarged view of a pixel 5 of a liquid crystal display device 1 of Embodiment 5.

### Configuration of TFT Substrate

In Embodiment 5, the gate line 13 of Embodiment 1 doubles as the scan line 17.

That is, as shown in FIG. 18, while the first electrode 41 is connected to the gate line 13 that is commonly used as the scan line 17 as the first wiring line, the second electrode 42 is connected to the detection line 18 as the second wiring line through the TFD 22. Also, the gate driver 51 of Embodiment 5 has the function of the scan driver 53.

In Embodiment 1, an example of arranging the TFD 22 between the second electrode 42 and the detection line 18 is described, but the present invention is not limited to this, and the TFD 22 that allows electric current to flow from the gate line 13 side to the detection line 18 side may be interposed at least one of between the first electrode 41 and the gate line 13 and between the second electrode 42 and the detection line 18.

The touch position detection can be performed in a manner similar to Embodiment 1 above. When a scan voltage is supplied to TFT 16 from the gate line 13 row by row, turning the TFT 16 to the ON state, the scan voltage is supplied to the first electrode 41 connected to this gate line 13 at the same time. Here, a signal voltage is supplied to the pixel electrode 15 from the source line 14 through the TFT 16 that is in the ON state, and an image is displayed in the pixel 5.

Meanwhile, if the first electrode 41 connected to the gate line 13 of the row that is being scanned is electrically connected to the second electrode 42 through the conductive layer 43 as a result of the TFT substrate 11 or the opposite substrate 12 being touched and pressed, the scan voltage supplied to the first electrode 41 is detected by the detection driver 54 through the TFD 22 and the detection line 18.

This series of processes is performed for every row of the gate line 13 row by row. The image display as well as the touch position detection are thereby performed for the entire display region 20.

### Effects of Embodiment 5

Therefore, according to Embodiment 5 as well, in a similar manner to Embodiment 1 above, each of the pairs of the first electrodes 41 and the second electrodes 42 is provided with the conductive layer 43 and the TFD 22. Also, the voltage of the gate driver 51 (scan driver 53) is supplied to the first electrodes 41 through a plurality of the gate lines 13, and the voltage supplied to the first electrode 41 at a touch position is detected by the detection driver 54 through the conductive layer 43, the second electrode 42, and the detection line 18. Therefore, by scanning the respective gate lines 13 sequentially, each touch position can be detected by a respective pair of the first electrode 41 and the second electrode 42 with high degree of accuracy, without detecting a wrong touch position even when two or more points are touched simultaneously.

Further, because the scan lines 17 double as the gate lines 13, the number of lines can be reduced, and therefore, the aperture ratio of the pixel 5 can be further improved compared to Embodiment 1 above.

### Other Embodiments

Although in each of the embodiments above, combinations of the second switching elements 22 and 23, the first wiring lines 13 and 17, and the second wiring lines 14 and 18 have been exemplified, this invention is not limited to this, and the TFD 22 or the TFT 23 as the second switching element, the scan line 17, the reference voltage line 17, or the gate line 13 as the first wiring line, the source line 14 or the detection line 18 as the second wiring line may be combined, respectively, to constitute a display device.

The first switching element is not limited to the TFT 16, and the second switching element is not limited to the TFD 22 or the TFT 23, and other switching elements may also be used.

In the embodiments above, all of the pixels 5 were provided with the first electrode 41, the second electrode 42, and the second switching element 22 or 23. However, the first electrode 41, the second electrode 42, and the second switching element 22 or 23 may be provided in at least two or more pixels 5.

Although examples of a liquid crystal display device have been described in the respective embodiments above, the present invention can also be applied to other display devices such as an organic EL display device whose display medium layer is a light-emitting layer, for example, in a similar manner.

### INDUSTRIAL APPLICABILITY

As described above, the present invention is useful for a display device that detects positional information on a display screen.

### DESCRIPTION OF REFERENCE CHARACTERS

1 liquid crystal display device
10 liquid crystal layer (display medium layer)
11 TFT substrate (first substrate)
12 opposite substrate (second substrate)
13 gate line (scan wiring line, first wiring line)
14 source line (signal wiring line, second wiring line)
15 pixel electrode
16 TFT (first switching element)
17 scan line, reference voltage line (first wiring line)
18 detection line (second wiring line)
19 scan line (third wiring line)
22 TFD (second switching element)
23 TFT (second switching element)
27 opposite electrode
41 first electrode
42 second electrode
43 conductive layer
51 gate driver (voltage supply portion)
52 source driver (detection portion)
53 scan driver (voltage supply portion)
54 detection driver (detection portion)

1. A display device, comprising:
a first substrate having thereon a plurality of pixel electrodes and a first switching element connected to said pixel electrode in each of a plurality of pixels;
a second substrate placed opposite to the first substrate;
a display medium layer disposed between the first substrate and the second substrate;
a plurality of first electrodes formed on the first substrate;
a plurality of second electrodes formed on the first substrate, the second electrodes being electrically insulated from each of the first electrodes and placed side by side with the first electrodes, respectively;
a plurality of conductive layers arranged on the second substrate so as to respectively face pairs of the first electrode and the second electrode placed side by side with each other, the plurality of conductive layers being formed to be electrically insulated from each other;
a plurality of first wiring lines and a plurality of second wiring lines formed on the first substrate;
a voltage supply portion for applying a voltage to the first electrodes through the first wiring lines;
a detection portion that detects a voltage applied to the first electrode by the voltage supply portion through the conductive layer, the second electrode, and the second wiring line as a result of the conductive layer making contact with the first electrode and the second electrode when the first substrate or the second substrate is pressed; and
a second switching element interposed at least one of between the first electrode and the first wiring line and between the second electrode placed side by side with said first electrode and the second wiring line.

2. The display device according to claim 1, wherein the second switching element is a thin film transistor.

3. The display device according to claim 2, wherein a third wiring line is connected to the second switching elements for applying a scan voltage to turn said second switching elements to the ON state.

4. The display device according to claim 2, wherein the second switching element is connected to the first wiring line, and is configured to be in the ON state when a voltage is supplied to the second switching element from the voltage supply portion through said first wiring line.

5. The display device according to claim 1, wherein the second switching element is a thin film diode.

6. The display device according to claim 1, further comprising a plurality of scan wiring lines and a plurality of signal wiring lines connected to the first switching elements on the first substrate, the second wiring lines being the signal wiring lines.

7. The display device according to claim 1, further comprising a plurality of scan wiring lines and a plurality of signal wiring lines connected to the first switching elements on the first substrate, the first wiring lines being the scan wiring lines.

8. The display device according to claim 1, further comprising an opposite electrode formed on the second substrate, the opposite electrode being electrically insulated from the conductive layers.

9. The display device according to claim 1, wherein the first electrodes and the second electrodes are made of a same material as that of the pixel electrodes.

10. The display device according to claim 1, wherein a pair of the first electrode and the second electrode is disposed in each of the plurality of pixels, respectively.

11. The display device according to claim 1, wherein the display medium layer is a liquid crystal layer.
